(19) United States
(12) Patent Application Publication
(10) Pub. No.: US 2015/0041473 A1
(43) Pub. Date: Feb. 12, 2015

(54) AUTOMOTIVE FILLER CAP

(71) Applicant: DAIKIN INDUSTRIES, LTD., Osaka-shi, Osaka (JP)

(72) Inventors: Tomihiko Yanagiguchi, Settsu-shi (JP); Yasuhiro Nakano, Settsu-shi (JP); Haruhisa Masuda, Settsu-shi (JP); Takahiro Kitahara, Settsu-shi (JP)

(73) Assignee: DAIKIN INDUSTRIES, LTD., Osaka-shi, Osaka (JP)

(21) Appl. No.: 14/383,925

(22) PCT Filed: Feb. 25, 2013
(86) PCT No.: PCT/JP2013/054812

§ 371 Date: Sep. 9, 2014

(30) Foreign Application Priority Data
Mar. 13, 2012 (JP) 2012-056300

(51) Int. Cl. B60K 15/04

(52) U.S. Cl. CPC B60K 15/0406; B60K 2015/0451; B60K 2015/0438
USPC 220/295

(57) ABSTRACT

The object of the present invention is to provide an automotive filler cap with excellent low adhesion property. The present invention relates to an automotive filler cap configured to be attached to a filler opening of an automobile, the automotive filler cap including a gasket configured to seal the filler opening by being pressed against the filler opening, the gasket being made of a composition that contains a fluororubber and a fluororesin, the fluororesin being precipitated on the surface of the gasket, the fluororesin comprising a copolymer that contains a polymerized unit based on tetrafluoroethylene and a polymerized unit based on hexafluoropropylene.

### TECHNICAL FIELD

The present invention relates to automotive filler caps such as an automotive fuel cap and an automotive oil filler cap.

### BACKGROUND ART

Automobiles are provided with filler openings for supplying fuel or oil. The filler openings are closed with filler caps.

An automotive fuel tank, for example, includes a main body, a filler tube that upwardly extends from the main body, and a filler opening on the top end of the filler tube. Fuel is supplied from the filler opening with a fueling nozzle. The filler opening is closed with a fuel filler cap that enables opening and closing of the filler opening freely. The fuel filler cap is provided with a rubber seal member for preventing diffusion of fuel steam into the air from a gap between the filler opening of the filler tube and the filler cap.

Examples of materials for seal members of automotive fuel filler caps include vinylidene fluoride-hexafluoropropylene copolymers (FKMs) and hydrogen-added butadiene acryl nitrile rubbers (HNBRs), as disclosed in Patent Literature 1.

An internal combustion engine of an automobile is provided with a cylinder head cover or the like having a filler opening for supplying a lubricant. The filler opening is kept closed with an oil filler cap, except for the time of feeding fuel to the engine. The oil filler cap is provided with a rubber seal member for preventing diffusion of fuel steam from a gap between the filler opening and the filler cap.

Examples of materials for seal members of oil filler caps include NBR rubber, as disclosed in Patent Literature 2.

Unfortunately, a seal member made of such materials as those disclosed in Patent Literature 1 or 2 may cause adhesion due to a reaction at interfaces between the seal member and the filler opening after a long-time contact thereof. This adhesion may cause a defect in the seal member.

To solve the above problem, Patent Literature 3 and 4 disclose an automotive fuel cap and an automotive oil filler cap with excellent low adhesion property, respectively. The fuel cap and the oil filler cap each include a gasket configured to seal a filler opening by being pressed against the filler opening. The gasket is made of a composition containing a fluororubber and a fluororesin, and the fluororesin is precipitated on the surface of the gasket. The fluororesin is a copolymer that contains a polymerized unit based on ethylene and a polymerized unit based on tetrafluoroethylene. The fluororubber is a polymer that contains a polymerized unit based on vinylidene fluoride.

Patent Literature 5 discloses a crosslinkable fluororubber composition which contains a fluororubber and a fluororesin and which is produced by co-coagulation of the fluororubber and the fluororesin; and a molded fluororubber product produced by crosslinking the crosslinkable fluororubber composition. However, Patent Literature 5 fails to disclose an automotive filler cap.

In the field of seal materials and the like, for example, a method of laminating a fluororesin fiber layer on the surface of a rubber is disclosed as a method of reducing the coefficient of friction without deteriorating the characteristics of the rubber (refer to Patent Literature 6).

### CITATION LIST

### Patent Literature

Patent Literature 1: JP 2009-74576 A
Patent Literature 2: JP H8-74553 A
Patent Literature 3: JP 2011-207471 A
Patent Literature 4: JP 2011-208636 A
Patent Literature 5: WO 2011/002080
Patent Literature 6: JP H7-227935 A

### SUMMARY OF INVENTION

### Technical Problem

Patent Literature 3 and 4 disclose that a gasket can have excellent low adhesion property by having, on the surface of the gasket, a precipitate of a fluororesin contained in a copolymer that contains a polymerized unit based on ethylene and a polymerized unit based on tetrafluoroethylene. Automotive filler caps, however, have been required to have still more excellent low adhesion property.

One of the objects of the present invention is to provide an automotive filler cap with excellent low adhesion property.

### Solution to Problem

The present invention provides an automotive filler cap configured to be attached to an automotive filler opening of an automobile, the automotive filler cap including a gasket configured to seal the filler opening by being pressed against the filler opening, the gasket being made of a composition that contains a fluororubber and a fluororesin, the fluororesin being precipitated on the surface of the gasket, the fluororesin containing a copolymer that contains a polymerized unit based on tetrafluoroethylene and a polymerized unit based on hexafluoropropylene.

The fluororubber is preferably a copolymer that contains a polymerized unit based on vinylidene fluoride and a polymerized unit based on at least one monomer selected from the group consisting of tetrafluoroethylene, hexafluoropropylene, and perfluoro(alkyl vinyl ether).

The automotive filler cap of the present invention is preferably an automotive fuel cap configured to be attached to a filler opening of a fuel tank of an automobile.

The automotive filler cap of the present invention is preferably an automotive oil filler cap configured to be attached to a filler opening for supplying a lubricant to an internal combustion engine of an automobile.

### Advantageous Effects of Invention

The automotive filler cap of the present invention has the above structure and thereby has excellent low adhesion property.

### BRIEF DESCRIPTION OF THE DRAWINGS

FIG. 1(a) is a perspective view schematically illustrating the shapes of protrusions of a gasket; FIG. 1(b) is a cross-sectional view of a protrusion 11 along the plane including the straight lines B₁ and B₂ perpendicular to the surface shown in FIG. 1(a); and FIG. 1(c) is a cross-sectional view along the plane including the straight lines C₁ and C₂ parallel with the surface shown in FIG. 1(a).

FIG. 2 is a schematic view illustrating an example of the structure of an automotive fuel cap. FIG. 2 is divided by a dashed line into two parts which include a left part illustrating a side view of the fuel cap and a right part illustrating a cross section of the fuel cap.

FIG. 3 is a schematic cross-sectional view illustrating an example of the structure of an automotive oil filler cap.

### DESCRIPTION OF EMBODIMENTS

The automotive filler cap of the present invention is an automotive filler cap configured to be attached to a filler opening of an automobile, the automotive filler cap including a gasket configured to seal the filler opening by being pressed against the filler opening, the gasket being made of a composition that contains a fluororubber and a fluororesin, the fluororesin being precipitated on the surface of the gasket, the fluororesin containing a copolymer that contains a polymerized unit based on tetrafluoroethylene and a polymerized unit based on hexafluoropropylene.

The automotive filler cap of the present invention includes a gasket that has a precipitate of a specific fluororesin on the surface. Thus, the gasket can have excellent low adhesion property in the portion in close contact with the filler opening.

The following describes the components constituting the gasket of the present invention.

### Fluororubber

A fluororubber typically contains an amorphous polymer which has a fluorine atom bonded to a carbon atom in the main chain and which has rubber elasticity. The fluororubber may consist of a single polymer or two or more polymers.

The fluororubber is preferably at least one selected from the group consisting of vinylidene fluoride (VdF)/hexafluoropropylene (HFP) copolymers, VdF/HFP/tetrafluoroethylene (TFE) copolymers, TFE/propylene copolymers, TFE/propylene/VdF copolymers, ethylene/HFP copolymers, ethylene/HFP/VdF copolymers, ethylene/HFP/TFE copolymers, VdF/TFE/perfluoro(alkyl vinyl ether) (PAVE) copolymers, and VdF/chlorotrifluoroethylene (CTFE) copolymers. The fluororubber is more preferably a copolymer containing a VdF unit because such a fluororubber can lead to an automotive filler cap with more excellent low adhesion property.

The following will describe a fluororubber which contains the copolymer containing a vinylidene fluoride (VdF) unit (hereinafter, also referred to as a VdF fluororubber). A VdF fluororubber is a fluororubber at least containing a polymerized unit derived from VdF.

The copolymer containing a VdF unit is preferably a copolymer containing a VdF unit and a copolymerized unit derived from a fluoroethylenic monomer (excluding a VdF unit). The copolymer containing a VdF unit preferably further contains a copolymerized unit derived from a monomer copolymerizable with VdF and with the fluoroethylenic monomer.

The copolymer containing a VdF unit preferably contains 30 to 90 mol % of a VdF unit and 70 to 10 mol % of a copolymer unit derived from a fluoroethylenic monomer, more preferably 30 to 85 mol % of a VdF unit and 70 to 15 mol % of a copolymerized unit derived from a fluoroethylenic monomer, still more preferably 30 to 80 mol % of a VdF unit and 70 to 20 mol % of a copolymer unit derived from a fluoroethylenic monomer. The amount of the copolymerized unit derived from a monomer copolymerizable with VdF and the fluoroethylenic monomer is preferably 0 to 10 mol % for the sum of the amounts of the VdF unit and the copolymerized unit derived from a fluoroethylenic monomer.

Examples of the fluoroethylenic monomer include TFE, CTFE, trifluoroethylene, HFP, trifluoropropylene, tetrafluoropropylene, pentafluoropropylene, trifluorobutene, tetrafluoroisobutene, PAVEs, vinyl fluoride, and fluoromonomers (e.g. fluorovinyl ether) represented by the formula (1):

CFX═CXOCF₂OR¹ (1)

wherein Xs may be the same as or different from each other and are each H, F, or CF₃; R¹ is a C₁-C₆ linear or branched fluoroalkyl group which may optionally contain one or two atom(s) selected from the group consisting of H, Cl, Br, and I, or a C₅-C₆ cyclic fluoroalkyl group which may optionally contain one or two atom(s) selected from the group consisting of H, Cl, Br, and I. The fluoroethylenic monomer is preferably at least one selected from the group consisting of fluorovinyl ethers represented by the formula (1), TFE, HFP, and PAVE, more preferably at least one selected from the group consisting of TFE, HFP, and PAVE.

The PAVE is preferably one represented by the formula (2):

CF₂═CFO(CF₂CFY¹O)ₚ−(CF₂CF₂CF₂O)_{q}—Rf (2)

wherein Y¹ is F or CF₃; Rf is a C₁-C₅ perfluoroalkyl group; p is an integer of 0 to 5; and q is an integer of 0 to 5.

The PAVE is more preferably perfluoro(methyl vinyl ether) or perfluoro(propyl vinyl ether), still more preferably perfluoro(methyl vinyl ether). Each of these may be used alone, or may be used in any combination.

Examples of the monomer copolymerizable with VdF and the fluoroethylenic monomer include ethylene, propylene, and alkyl vinyl ether.

The copolymer containing a VdF unit is preferably a copolymer containing a polymerized unit based on VdF and a polymerized unit based on at least one monomer selected from the group consisting of TFE, HFP, and PAVE. This copolymer is preferably at least one copolymer selected from the group consisting of VdF/HFP copolymers, VdF/HFP/TFE copolymers, VdF/CTFE copolymers, VdF/CTFE/TFE copolymers, VdF/PAVE copolymers, VdF/TFE/PAVE copolymers, VdF/HFP/PAVE copolymers, and VdF/HFP/TFE/PAVE copolymers. Among these copolymers including a VdF unit, at least one copolymer selected from the group consisting of VdF/HFP copolymers and VdF/HFP/TFE copolymers is particularly preferred in terms of heat resistance. These copolymers including a VdF unit preferably satisfy the aforementioned compositional ratio between the VdF unit and the copolymerized unit derived from a fluoroethylenic monomer.

The VdF/HFP copolymers preferably satisfy a molar ratio VdF/HFP of (45 to 85)/(55 to 15), more preferably (50 to 80)/(50 to 20), still more preferably (60 to 80)/(40 to 20).

The VdF/HFP/TFE copolymers preferably satisfy a molar ratio VdF/HFP/TFE of (40 to 80)/(10 to 35)/(10 to 35).

The VdF/PAVE copolymers preferably satisfy a molar ratio VdF/PAVE of (65 to 90)/(10 to 35).

The VdF/TFE/PAVE copolymers preferably satisfy a molar ratio VdF/TFE/PAVE of (40 to 80)/(3 to 40)/(15 to 35).

The VdF/HFP/PAVE copolymer preferably satisfies a molar ratio VdF/HFP/PAVE of (65 to 90)/(3 to 25)/(3 to 25).

The VdF/HFP/TFE/PAVE copolymers preferably satisfy a molar ratio VdF/HFP/TFE/PAVE of (40 to 90)/(0 to 25)/(0 to 40)/(3 to 35), more preferably (40 to 80)/(3 to 25)/(3 to 40)/(3 to 25).

The fluororubber also preferably contains a copolymer containing a copolymerized unit derived from a monomer that gives a crosslinking moiety. Examples of the monomer that gives a crosslinking moiety include iodine-containing monomers such as perfluoro(6,6-dihydro-6-iodo-3-oxa-1-hexene) and perfluoro(5-iodo-3-oxa-1-pentene) disclosed in JP H05-63482 B and JP H07-316234 A, bromine-containing monomers disclosed in JP H04-505341 T, and cyano group-containing monomers, carboxyl group-containing monomers, and alkoxy carbonyl group-containing monomers disclosed in JP H04-505345 T and JP H05-500070 T.

The fluororubber is also preferably a fluororubber having an iodine or bromine atom at a terminus of the main chain. The fluororubber having an iodine or bromine atom at a terminus of the main chain can be produced by emulsion polymerization of a monomer using a radical initiator in the presence of a halogen compound in an aqueous medium substantially without oxygen. Representative examples of the halogen compound to be used include compounds represented by the formula:

R²IₓBr_{y}

wherein x and y each are an integer of 0 to 2 and they satisfy 1≦x+y≦2; R² is a C₁-C₁₆ saturated or unsaturated fluorohydrocarbon group, a C₁-C₁₆ saturated or unsaturated chlorofluorohydrocarbon group, a C₁-C₃ hydrocarbon group, or a C₃-C₁₀ cyclic hydrocarbon group which may optionally be substituted by an iodine or bromine atom. Each of these groups may optionally have an oxygen atom.

Examples of the halogen compound include 1,3-diiodoperfluoropropane, 1,3-diiodo-2-chloroperfluoropropane, 1,4-diiodoperfluorobutane, 1,5-diiodo-2,4-dichloroperfluoropentane, 1,6-diiodoperfluorohexane, 1,8-diiodoperfluorooctane, 1,12-diiodoperfluorododecane, 1,16-diiodoperfluorohexadecane, diiodomethane, 1,2-diiodoethane, 1,3-diiodo-n-propane, CF₂Br₂, BrCF₂CF₂Br, CF₃CFBrCF₂Br, CFClBr₂, BrCF₂CFClBr, CFBrClCFClBr, BrCF₂CF₂CF₂Br, BrCF₂CFBrOCF₃, 1-bromo-2-iodoperfluoroethane, 1-bromo-3-iodoperfluoropropane, 1-bromo-4-iodoperfluorobutane, 2-bromo-3-iodoperfluorobutane, 3-bromo-4-iodoperfluorobutene-1,2-bromo-4-iodoperfluorobutene-1, monoiodo-monobromo substitution products of benzene, diiodo-monobromo substitution products of benzene, and (2-iodoethyl) and (2 bromoethyl) substitution products of benzene. These compounds may be used alone or in combination of two or more thereof.

Among these, 1,4-diiodoperfluorobutane or diiodomethane is preferred in terms of properties such as polymerization reactivity, crosslinking reactivity, and easy availability.

The fluororubber preferably has a Mooney viscosity (ML₁₊₁₀ (100° C.)) of 5 to 140, more preferably 10 to 120, still more preferably 20 to 100, for good processability.

The Mooney viscosity can be determined in conformity with ASTM-D1646, using the following measurement device under the following measuring conditions, for example.

Measurement device: MV2000E (ALPHA TECHNOLOGIES Inc.)
Rotational speed of rotor: 2 rpm
Measurement temperature: 100° C.

The aforementioned composition may contain various known compounding agents and additives optionally added to a fluororubber, such as fillers, processing aids, plasticizers, colorants, stabilizers, adhesive aids, release agents, electro-conductivity-imparting agents, thermal-conductivity-imparting agents, surface non-adhesive agents, flexibility-imparting agents, heat-resistance improvers, and flame retarders. These additives and compounding agents may be used to the extent that they do not adversely affect the effects of the present invention.

### Fluororesin

The fluororesin contain a copolymer (hereinafter, also referred to as “FEP”) containing a polymerized unit based on tetrafluoroethylene (TFE) and a polymerized unit based on hexafluoropropylene (HFP). The FEP imparts excellent low adhesion property to the automotive filler cap of the present invention. The FEP is also preferred in that it imparts excellent heat and oil resistances to the automotive filler cap.

The fluororesin is preferably a perfluoro fluorine resin because it imparts more excellent low adhesion property to the automotive filler cap.

The FEP is preferably a copolymer that contains 70 to 99 mol % of a TFE unit and 1 to 30 mol % of a HFP unit, more preferably a copolymer that contains 80 to 97 mol % of a TFE unit and 3 to 20 mol % of a HFP unit. Less than 70 mol % of a TFE unit tends to deteriorate the mechanical properties, whereas more than 99 mol % thereof tends to cause too high a melting point and thereby to deteriorate the moldability.

The FEP may be a copolymer containing TFE, HFP, and a monomer copolymerizable with TFE and HFP. Examples of such a monomer include perfluoro(alkyl vinyl ethers) (PAVEs) represented by CF₂═CF—ORf⁶ (wherein Rf⁶ is a C₁-C₅ perfluoroalkyl group); vinyl monomers represented by CX⁵X⁶═CX⁷(CF₂)ₙX⁸ (wherein X⁵, X⁶, and X⁷ are the same as or different from each other, and each are a hydrogen or fluorine atom; X⁸ is a hydrogen, fluorine, or chlorine atom; n is an integer of 2 to 10); and alkyl perfluorovinyl ether derivatives represented by CF₂═CF—OCH₂—Rf⁷ (wherein Rf⁷ is a C₁-C₅ perfluoroalkyl group). PAVEs are preferred among these.

The PAVE is preferably at least one selected from the group consisting of perfluoro(methyl vinyl ether) (PMVE), perfluoro(ethyl vinyl ether) (PEVE), perfluoro(propyl vinyl ether) (PPVE), and perfluoro(butyl vinyl ether). It is more preferably at least one selected from the group consisting of PMVE, PEVE, and PPVE.

The alkyl perfluorovinyl ether derivative is preferably one in which Rf⁷ is a C₁-C₃ perfluoroalkyl group, more preferably one represented by CF₂═CF—OCH₂—CF₂CF₃.

For a FEP containing a monomer unit which is derived from a monomer copolymerizable with TFE and HFP, the amount of the monomer unit derived from a monomer copolymerizable with TFE and HFP is preferably 0.1 to 10 mol % and the sum of the amounts of the TFE unit and the HFP unit is preferably 90 to 99.9 mol %. Less than 0.1 mol % of the copolymerizable monomer unit tends to deteriorate moldability, environmental stress-crack resistance, and stress-crack resistance. More than 10 mol % thereof tends to deteriorate properties such as heat resistance, mechanical properties, and productivity. More preferably, for the FEP containing a monomer unit which is derived from a monomer copolymerizable with TFE and HFP, the amount of the monomer unit derived from a monomer copolymerizable with TFE and HFP is 0.1 to 9 mol % and the sum of the amounts of the TFE unit and the HFP unit is 91 to 99.9 mol %.

The melting point of the fluororesin is preferably not lower than the crosslinking temperature of the fluororubber. Though a preferable range of the melting point of the fluororesin depends on the type of the fluororubber, the melting point is preferably 150° C. or higher, more preferably 180° C. or higher, provided that these temperatures are not lower than the crosslinking temperature of the fluororubber. The upper limit is not particularly limited, and may be 300° C. In order to provide an automotive filler cap with more excellent low adhesion property, the melting point of the fluororesin is preferably 230° C. or lower, more preferably 220° C. or lower.

Too low a melting point may cause melting of the fluororesin upon crosslinking and molding, likely failing to give an automotive filler cap with a desired shape. In addition, such a low melting point may fail to cause sufficient precipitation of a fluororesin on the surface of a gasket. Such a low melting point may also prevent a gasket from having a sufficient number of protrusions as mentioned below.

The fluororesin preferably has a melt flow rate (MFR) at 327° C. of 0.3 to 100 g/10 min. Too low a MFR may make it impossible to sufficiently form protrusions on the surface, likely resulting in poor low adhesion property. Too high a MFR may make it impossible to mold the resin. The MFR can be determined at 327° C. and at a 5-kg load in conformity with ASTM D3307-01.

For a fluororesin having a melting point of not higher than 200° C., the MFR is measured at 280° C. In this case, the fluororesin preferably has a MFR at 280° C. of 0.3 to 100 g/10 min. The MFR is determined at 280° C. at a 5-kg load in conformity with ASTM D3307-01.

The automotive filler cap preferably has a gasket with a low compression set in terms of having more excellent sealing performance. In order to reduce the compression set of the automotive filler cap, the fluororesin is preferably at least one selected from the group consisting of fluororesins (B1) and (B2) each having the following specific composition.

The fluororesins (B1) and (B2) each are a copolymer containing a tetrafluoroethylene (TFE) unit and a hexafluoropropylene (HFP) unit at a specific composition. Use of the fluororesin (B1) or (B2) having a specific composition further improves the low adhesion property of the automotive filler cap of the present invention as well as the property for reducing the compression set of the gasket.

The fluororesins (B1) and (B2) are also preferable in that they have excellent compatibility with the fluororubber and allow the resulting automotive filler cap to have excellent heat resistance.

The fluororesin (B1) is a copolymer consisting only of a TFE unit (a) and a HFP unit (b) with a molar ratio (TFE unit (a)/HFP unit (b)) of 80.0 to 87.3/12.7 to 20.0. The fluororesin (B1) having the above specific composition markedly reduces the compression set of the gasket.

In order to provide a still lower compression set and excellent mechanical properties, the fluororesin (B1) preferably satisfies a molar ratio (a)/(b) of 82.0 to 87.0/13.0 to 18.0, more preferably 83.0 to 86.5/13.5 to 17.0, still more preferably 83.0 to 86.0/14.0 to 17.0. Too high a ratio (a)/(b) may fail to reduce the compression set of the gasket sufficiently. Too low a ratio (a)/(b) tends to deteriorate the mechanical properties.

The fluororesin (B2) is a copolymer containing a tetrafluoroethylene unit (a), a hexafluoropropylene unit (b), and a polymer unit (c) based on a monomer copolymerizable with tetrafluoroethylene and hexafluoropropylene with a molar ratio (a)/(b) of 80.0 to 90.0/10.0 to 20.0 and a molar ratio (c)/{(a)+(b)} of 0.1 to 10.0/90.0 to 99.9, wherein {(a)+(b)} means the sum of the tetrafluoroethylene unit (a) and the hexafluoropropylene unit (b). The fluororesin (B2) with a molar ratio (a)/(b) of 80.0 to 90.0/10.0 to 20.0 and a molar ratio (c)/{(a)+(b)} of 0.1 to 10.0/90.0 to 99.9 markedly reduces the compression set.

In order to further reduce the compression set and to provide excellent mechanical properties, the fluororesin (B2) preferably satisfies a molar ratio (a)/(b) of 82.0 to 88.0/12.0 to 18.0, more preferably 84.0 to 88.0/12.0 to 16.0. Too high a ratio (TFE unit (a)/HFP unit (b)) may fail to reduce the compression set of the gasket sufficiently. Furthermore, such a high ratio tends to cause too high a melting point and thus to deteriorate the moldability. Too low a ratio (TFE unit (a)/HFP unit (b)) tends to deteriorate the mechanical properties.

The fluororesin (B2) preferably satisfies a molar ratio (c)/{(a)+(b)} of 0.3 to 8.0/92.0 to 99.7.

The monomer copolymerizable with TFE and HFP, to be contained in the fluororesin (B2), may be the same as those mentioned above.

The polymerized unit (c) based on a monomer copolymerizable with TFE and HFP, which is to be contained in the fluororesin (B2), is preferably a PAVE unit. The fluororesin (B2) is more preferably a copolymer consisting only of a TFE unit, a HFP unit, and a PAVE unit.

The fluororesins (B1) and (B2) each preferably have a melting point of 210° C. or lower. The melting point is more preferably 130° C. to 210° C., still more preferably 150° C. to 200° C., particularly preferably 160° C. to 190° C. The fluororesins having a melting point of lower than 130° C. may bleed out upon crosslinking and molding, likely failing to have sufficient low adhesion property. The fluororesins having a melting point of higher than 210° C. may have a high storage elastic modulus and thus disadvantageously deteriorate the property for reducing the compression set of the gasket.

In order to reduce the compression set of the gasket, the fluororesins (B1) and (B2) each preferably have a storage elastic modulus (E′) by dynamic viscoelasticity measurement at 70° C. of 10 to 160 MPa.

The storage elastic modulus is a value measured by dynamic viscoelasticity measurement at 70° C. More specifically, it is a value measured on a sample of 30 mm in length×5 mm in width×0.5 mm in thickness using a dynamic viscoelasticity analyzer DVA220 (IT KEISOKU SEIGYO K.K.) in the following conditions: tensile mode, grip width: 20 mm, measurement temperature: 25° C. to 200° C., temperature-increasing rate: 2° C./min, and frequency: 1 Hz. The storage elastic modulus (E′) at 70° C. is preferably 10 to 160 MPa, more preferably 20 to 140 MPa, still more preferably 30 to 100 MPa.

The gasket is made of a composition that contains the fluororesin and the fluororubber. The fluororesin and the fluororubber are mixed in the composition. In other words, for example, the fluororubber is dispersed in the fluororesin or the fluororesin is dispersed in the fluororubber. Having such a structure clearly distinguishes the gasket of the present invention from other gaskets in which a fluororesin layer is laminated on the surface of a fluororubber or in which a fluororesin coating film is formed on the surface of a fluororubber. The gasket made of a composition that contains the fluororesin and the fluororubber does not suffer from peeling as seen in the other gaskets in which a fluororesin layer is laminated on the surface of a fluororubber or in which a fluororesin coating film is formed on the surface of a fluororubber.

The gasket, which is made of a composition that contains the fluororesin and the fluororubber, is more excellent in properties such as heat resistance and chemical resistance than gaskets made of a general-purpose rubber such as NBR.

The gasket contains a precipitate of the fluororesin on the surface. The gasket with a precipitate of the fluororesin on the surface can have more excellent low adhesion property than gaskets having a fluororubber surface. Since the fluororesin and the fluororubber are integrated in the gasket, the gasket is more excellent in flexibility than the other gaskets in which a fluororesin layer is laminated on a fluororubber surface or in which a coating film made of a fluororesin is formed on a fluororubber surface. Furthermore, the gasket with a precipitate of the fluororesin on the surface is excellent in anti-stick property, low friction property, water and oil repellency (high contact angle), heat resistance, and chemical resistance.

The gasket is useful as a gasket of an automotive filler cap with advantages of the low adhesion property, anti-stick property, low friction property, and water and oil repellency (high contact angle).

The fluororesin on the surface of the gasket may have protrusions or may be formed into a film.

The automotive filler cap of the present invention preferably has protrusions on the surface of the gasket. In this case, the protrusions are preferably substantially made of the fluororesin contained in the composition. The protrusions and the gasket have no clear interfaces therebetween, that is, the protrusions are integrally formed with the gasket.

In other words, the gasket is preferably made of a composition that contains the fluororubber and the fluororesin and has, on the surface of the gasket, protrusions substantially made of the fluororesin contained in the composition. The protrusions formed on the surface of the gasket allow the automotive filler cap of the present invention to have excellent low adhesion property.

The protrusions are substantially formed of the fluororesin contained in the composition. The protrusions can be formed, by a method of producing an automotive filler cap to be mentioned later, for example, by allowing the fluororesin contained in a crosslinkable composition produced in the below-mentioned mixing step (I) to precipitate on the surface of the gasket.

The protrusions have no clear interfaces with the gasket, and thus are integrally formed with the gasket. This structure more securely gives an effect of suppressing removal and breakage of the protrusions.

The fact that the protrusions are substantially formed of the fluororesin contained in the composition containing the fluororubber and the fluororesin can be verified by determining the ratio between the peak assigned to the fluororubber and the peak assigned to the fluororesin by IR analysis or ESCA. Specifically, in the region having the protrusions, the ratio (ratio between the peaks assigned to components) between the peak of characteristic absorption assigned to the fluororubber and the peak of characteristic absorption assigned to the fluororesin is determined by IR analysis at a portion with the protrusions and at a portion without the protrusions. The ratio (peak with protrusions)/(peak without protrusions) (=ratio between peaks) should be 1.2 or higher, preferably 1.5 or higher, more preferably 2.0 or higher.

The shapes of the protrusions will be described in detail below referring to the drawings.

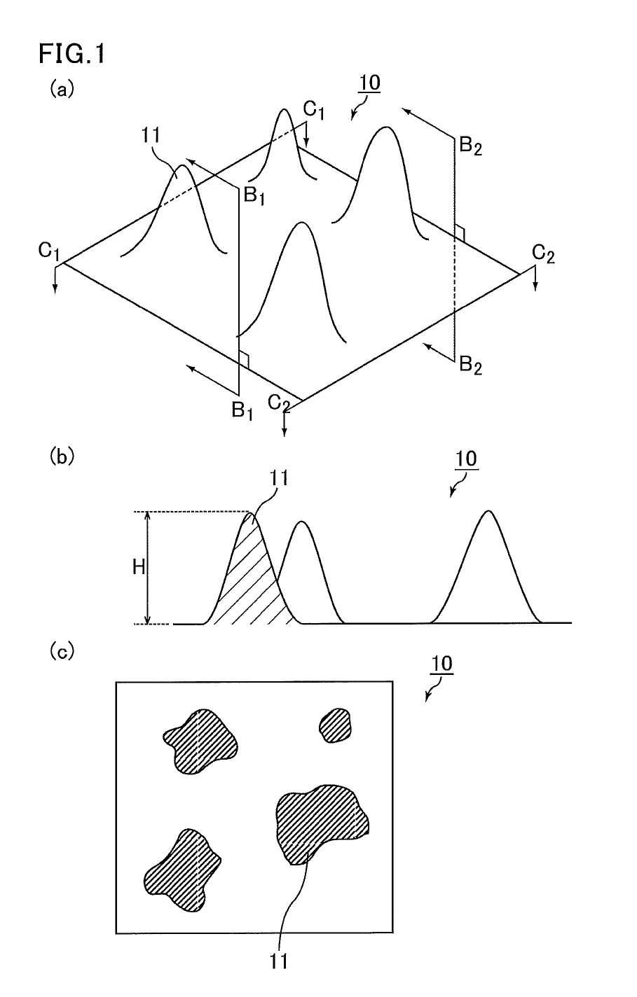

FIG. 1(a) is a perspective view schematically showing the shapes of the protrusions on a gasket; FIG. 1(b) is a cross-sectional view of one of protrusions 11 along the plane including the straight lines B₁ and B₂ perpendicular to the surface shown in FIG. 1(a); and FIG. 1(c) is a cross-sectional view along the plane including the straight lines C₁ and C₂ parallel with the surface shown in FIG. 1(a). FIGS. 1(a) to 1(c) schematically show a very small region on the surface of the gasket of the present invention. As shown in FIGS. 1(a) to 1(c), the surface of the gasket of the present invention has the protrusions 11 each having, for example, a substantially conical shape.

The height of each protrusion 11 means the height of a portion projected from the surface of the gasket (see the symbol H in FIG. 1(b)). The bottom cross-sectional area of each protrusion 11 means the area of the cross section of the protrusion 11 along the plane (the plane including the straight lines C₁ and C₂) parallel with the surface of the gasket (see FIG. 1(c)).

The proportion of the area of the region having protrusions on the surface of the gasket (the occupancy of protrusions) is preferably 0.06 (6%) or higher. The proportion of the area is more preferably 0.15 (15%) or higher, still more preferably 0.20 (20%) or higher, particularly preferably 0.25 (25%) or higher, and most preferably 0.30 (30%) or higher. The proportion of the area of the region having protrusions on the surface of the gasket means the proportion of the area of the protrusions on the cross section for evaluating the bottom cross-sectional area of the protrusions.

The proportion of the volume of the fluororesin in the gasket is preferably 0.05 to 0.45 (5 to 45% by volume) to the volume of the gasket. The lower limit of the proportion of the volume is more preferably 0.10 (10% by volume), still more preferably 0.15 (15% by volume), and particularly preferably 0.20 (20% by volume). The upper limit of the proportion of the volume is preferably 0.40 (40% by volume), more preferably 0.35 (35% by volume), and still more preferably 0.30 (30% by volume).

The fluororesin is a copolymer including a polymerized unit based on tetrafluoroethylene and a polymerized unit based on hexafluoropropylene, and has excellent heat resistance. Thus, the fluororesin is not decomposed through the step of crosslinking and molding or the step of heating to be mentioned later, and the proportion of the volume of the fluororesin in the gasket can be considered as the proportion of the volume of the fluororesin contained in the crosslinkable composition to be mentioned later.

The automotive filler cap of the present invention preferably satisfies that the proportion of the area of the region having protrusions on the surface of the gasket is 1.2 times or more, and more preferably 1.3 times or more, of the proportion of the volume of the fluororesin in the gasket, i.e., the proportion of the volume of the fluororesin in the composition containing fluororubber and fluororesin. This means that the proportion of the region having protrusions on the surface of the gasket is higher than the proportion of the volume of the fluororesin in the gasket, i.e., the proportion of the volume of the fluororesin in the composition containing the fluororubber and the fluororesin.

Even though the proportion of the fluororesin mixed is low, due to this characteristic, the automotive filler cap of the present invention improve the low adhesion property, which is a disadvantage of fluororubber, and does not deteriorate the elasticity, which is an advantage of fluororubber.

When the proportion of the area of the region having the protrusions is achieved at least in the part where the gasket and the filler opening are in contact with each other, the effects of the present invention can be sufficiently exerted.

The protrusions are each preferably 0.1 to 30.0 μm in height. Protrusions having heights within this range can impart more excellent low adhesion property to the automotive filler cap of the present invention without deteriorating the sealability. The height is more preferably 0.3 to 20.0 μm, still more preferably 0.4 to 10.0 μm. The height of the protrusions may be 0.5 to 10.0 μm.

The protrusions are each preferably 0.1 to 2000 μm² in bottom cross-sectional area. Protrusions having bottom cross-sectional areas within this range can impart more excellent low adhesion property to the automotive filler cap of the present invention. The bottom cross-sectional area is more preferably 0.3 to 1500 μm², still more preferably 0.5 to 1000 μm².

The gasket preferably satisfies that the standard deviation of the heights of the protrusions is 0.300 or lower. Protrusions having a standard deviation satisfying this upper limit can impart still more excellent low adhesion property to the automotive filler cap of the present invention.

The number of the protrusions on the surface of the gasket is preferably the 500 to 60000 pcs/mm². The number of the protrusions within this range imparts more excellent low adhesion property to the automotive filler cap of the present invention. The number of the protrusions may also be not less than 4000 pcs/mm² for still more excellent low adhesion property.

The proportion of the area of the region having protrusions, the heights of protrusions, the bottom cross-sectional areas of protrusions, the number of protrusions, and the like parameters can be calculated using a color 3D laser microscope (VK-9700, Keyence Corp.) and WinRooF Ver.6.4.0 (MITANI CORP.) as an analysis software. The proportion of the area of the region having protrusions can be determined as follows: the bottom cross-sectional area of each protrusion is measured, and the sum of the bottom cross-sectional areas is calculated as the proportion in the whole area measured. The number of protrusions is the number of protrusions within the region measured in terms of the number per mm².

Another preferred mode of the fluororesin on the surface of the gasket is a fluororesin film. The fluororesin film is formed of a precipitate of the fluororesin contained in the composition. A gasket having such a fluororesin film on the surface allows the automotive filler cap of the present invention to have excellent low adhesion property. The gasket has no clear interfaces between the fluororesin film formed on the surface and the inside of the gasket, that is, the fluororesin film is integrally formed with the inside of the gasket. Though the fluororesin film may cover the entire surface of the gasket, the film has no necessity for covering the entire surface and there may be a part where the fluororubber is exposed on the surface of the gasket.

The automotive filler cap of the present invention may be used as an automotive fuel cap or an automotive oil filler cap, for example.

The automotive filler cap of the present invention is excellent in oil resistance and in fuel barrier property, and thus is particularly suitable for an automotive fuel cap.

In the following, an embodiment of the automotive fuel cap is described referring to the figures.

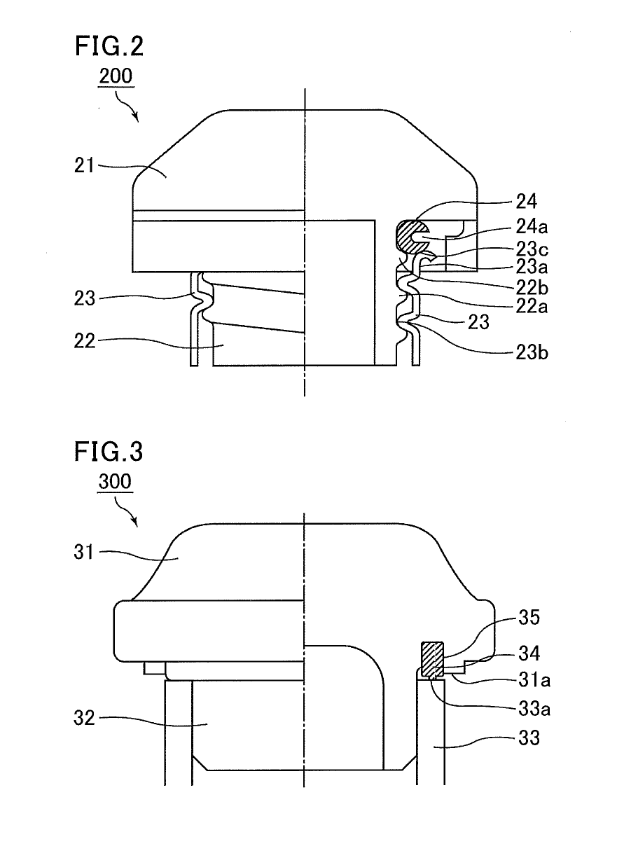

FIG. 2 is a schematic view illustrating an example of the structure of the automotive fuel cap of the present invention. The automotive fuel cap of the present invention may have the following structure, as illustrated in FIG. 2. An automotive fuel cap 200 consists of a cap portion 21 and a screw portion 22 with a thread 22a. A filler neck 23 connected to a fuel tank has a filler opening 23a on which a filler neck-side screw 23b is formed. The automotive fuel cap 200 can be attached to a filler opening by screwing the screw portion 22 with the thread 22a onto the filler neck-side screw 23b of the filler opening 23a. The cap portion 21 may be made of a synthesized resin material such as nylon or may be made of other materials. Such an automotive fuel cap normally includes a gripper on the top for turning the cap portion 21. The screw portion 22 has a cylindrical shape with the thread 22a which is configured to be screwed onto the filler neck-side screw 23b of the filler neck 23.

A gasket 24 is typically mounted on the upper periphery of the screw portion 22. The gasket 24 seals the filler opening 23a when the automotive fuel cap 200 is screwed onto the filler opening 23a of the filler neck 23, whereby the gasket 24 is pressed against a sealing surface 23c of the filler opening 23a. On the upper periphery of the screw portion 22, a rib 22b is normally formed to prevent removal of the gasket 24.

Between the cap portion 21 and the screw portion 22, a ratchet mechanism is typically provided though it is not illustrated in FIG. 2. The ratchet mechanism allows one way rotation of the cap portion 21. The ratchet mechanism also allows spinning of the cap portion 21 when the rotation thereof exceeds a predetermined torque, to prevent the automotive fuel cap 200 from being attached too tightly to the filler opening 23a.

The automotive fuel cap of the present invention includes a gasket configured to seal a filler opening by being pressed against the filler opening. As illustrated in FIG. 2, the gasket 24 can seal the filler opening 23a of the filler neck 23 when the gasket 24 is brought into contact with the filler opening 23a and is pressed against the sealing surface 23c of the filler neck 23.

The gasket, as described in the above, may have any shape, provided that it can seal the filler opening. Typically, the gasket has a ring shape and is attached to the periphery of the screw portion of the automotive fuel cap, as described above. The cross section of the gasket may be a circle, a polygon (e.g. a triangle, a tetragon, a pentagon, and a hexagon), or other shapes. The cross section of the gasket may be a circle with a slit 24a (C shape) as illustrated in FIG. 2, for example.

The automotive filler cap of the present invention is excellent in low adhesion property, oil resistance, and heat resistance, and is thus particularly suitable as an automotive oil filler cap.

FIG. 3 is a schematic cross-sectional view illustrating an example of the structure of the automotive oil filler cap of the present invention. The automotive oil filler cap of the present invention may have the following structure, as illustrated in FIG. 3. An automotive oil filler cap 300 consists of a cap portion 31 and a cylindrical portion 32 and is configured to be attached to a filler opening. The cap portion 31 may be made of a synthesized resin material such as nylon or may be made of a metal. If the filler opening has a thread, the cylindrical portion 32 may have a thread configured to be screwed onto the thread of the filler opening. If the filler opening has no thread, no thread is required on the cylindrical portion 32. A gasket 34 is typically mounted in a groove 35 which is provided at a bottom surface 31a of the cap portion 31 along the periphery of the cylindrical portion 32. The gasket in the automotive oil filler cap 300 seals the filler opening 33 by being pressed against the sealing surface 33a of the filler opening.

The gasket, as described above, may have any shape, provided that it can seal a filler opening. Typically, the gasket has a ring shape and is attached to the bottom surface of the cap of an oil filler cap along the periphery of the cylinder portion as mentioned above. The cross section of the gasket may be a circle, a polygon (e.g. a triangle, a tetragon, a pentagon, and a hexagon), or other shapes.

Next, a method of producing the automotive filler cap of the present invention will be described in the following.

The gasket of the automotive filler cap of the present invention can be produced by crosslinking a crosslinkable composition containing an uncrosslinked fluororubber and the fluororesin. In particular, the automotive filler cap of the present invention is preferably one produced by the following production method.

The automotive filler cap of the present invention can be produced by preparing a gasket having a predetermined shape through a process including the steps of:

(I) mixing a fluororesin and an uncrosslinked fluororubber;

(II) crosslinking and molding the resulting mixture; and

(III) heating the resulting molded, crosslinked product to a temperature not lower than the melting point of the fluororesin,

and then mounting the resultant gasket on a predetermined position such as a cap portion or a cylindrical portion of the automotive filler cap.

The uncrosslinked fluororubber is a fluororubber before crosslinking.

### (I) Mixing

The crosslinkable composition may be prepared by any method capable of uniformly mixing the uncrosslinked fluororubber and the fluororesin. Examples of the method include mixing of uncrosslinked fluororubber powder and fluororesin powder each separately prepared by coagulation; melt-kneading of the uncrosslinked fluororubber and the fluororesin; and co-coagulation of the uncrosslinked fluororubber and the fluororesin. Among these, melt-kneading of the uncrosslinked fluororubber and the fluororesin and co-coagulation of the uncrosslinked fluororubber and the fluororesin are preferred.

Melt-kneading and co-coagulation are described below.

### (Melt-Kneading)

Melt-kneading of the uncrosslinked fluororubber and the fluororesin is performed at a temperature equal to or higher than the temperature 5° C. lower than the melting point of the fluororesin, preferably at a temperature not lower than the melting point of the fluororesin. The upper limit of the temperature for the melt-kneading is below the lower one of the pyrolysis temperatures of the uncrosslinked fluororubber and the fluororesin.

The melt-kneading is not performed in the conditions which cause crosslinking at the temperature for the melt-kneading, such as in the presence of a crosslinker, a crosslinking accelerator, and an acid acceptor. Meanwhile, any of components (e.g. a specific crosslinker alone, a combination of only a crosslinker and a crosslinking accelerator) which do not cause crosslinking at a melt-kneading temperature, which is not lower than the temperature 5° C. lower than the melting point of the fluororesin, may be added to the mixture of the uncrosslinked fluororubber and the fluororesin during the melt-kneading. Examples of the conditions causing crosslinking include combination use of a polyol crosslinker, a crosslinking accelerator, and an acid acceptor.

Thus, the melt-kneading is preferably performed in a two-stage kneading manner in which the uncrosslinked fluororubber and the fluororesin are melt-kneaded to prepare a pre-compound (pre-mixture), and then the pre-compound is mixed with other additives and compounding agents at a temperature lower than the crosslinking temperature to prepare a full compound (crosslinkable composition). It may of course be possible to knead all the components at a temperature lower than the crosslinking temperature of the crosslinker.

The melt-kneading of the fluororubber and the fluororesin may be performed at a temperature which is not lower than the temperature 5° C. lower than the melting point of the fluororesin (e.g. 180° C. or higher, typically 220° C. to 300° C.) using a Banbury mixer, a pressure kneader, an extruder, or the like. It is preferable to use a pressure kneader or an extruder such as a twin-screw extruder because such a device can apply a high shearing force.

In two-stage kneading, the melt-kneaded product may be prepared into a full compound at a temperature lower than the crosslinking temperature (e.g. 100° C. or lower) using an open roll, a Banbury mixer, a pressure kneader, or the like.

A treatment similar to the melt-kneading is crosslinking the fluororubber in the fluororesin in a molten form (dynamic crosslinking). Dynamic crosslinking is a method in which an uncrosslinked rubber is blended into a matrix of a thermoplastic resin and thereby the uncrosslinked rubber is crosslinked under kneading, and the crosslinked rubber is micro-dispersed in the matrix. This treatment essentially differs from the melt-kneading in that the melt-kneading is performed in the conditions causing no crosslinking (e.g. in the absence of components required for crosslinking, or composition which is not crosslinked at that temperature), and that the matrix of the mixture in melt-kneading is uncrosslinked rubber and the fluororesin is uniformly dispersed in the uncrosslinked rubber.

### (Co-Coagulation)

The mixing (I) is preferably performed such that the uncrosslinked fluororubber and the fluororesin are co-coagulated to prepare a coagulated product from which a crosslinkable composition containing the coagulated product is produced.

The crosslinkable composition containing the coagulated product enables uniform precipitation of the fluororesin on the surface of the gasket, formation of more uniform and fine protrusions, and a more sufficient increase in the proportion (occupancy) by area of the regions having the protrusions. As a result, an automotive filler cap with more excellent low adhesion property can be produced.

In the crosslinkable composition containing a coagulated product produced by co-coagulating the uncrosslinked fluororubber and the fluororesin, the uncrosslinked fluororubber and the fluororesin are assumed to be uniformly dispersed in the crosslinkable composition. Crosslinking and heating such a crosslinkable composition presumably produces the automotive filler cap of the present invention excellent in low adhesion property.

Examples of the method for the co-coagulation include (i) coagulation after mixing an aqueous dispersion of the uncrosslinked fluororubber and an aqueous dispersion of the fluororesin; (ii) coagulation after adding powder of the uncrosslinked fluororubber to an aqueous dispersion of the fluororesin; and (iii) coagulation after adding powder of the fluororesin to an aqueous dispersion of the uncrosslinked fluororubber. The co-coagulation is preferably performed by the method (i) because the uncrosslinked fluororubber and the fluororesin are easily uniformly dispersed.

The coagulation by the methods (i) to (iii) may be performed using a coagulant. Any coagulant may be used, and examples thereof include known coagulants, including aluminum salts such as aluminum sulfate and alum; calcium salts such as calcium sulfate; magnesium salts such as magnesium sulfate and magnesium chloride; and monovalent cation salts such as sodium chloride and potassium chloride. In coagulation using a coagulant, an acid or alkali may be additionally used to adjust the pH, thereby accelerating the coagulation.

The coagulated product obtainable by co-coagulating uncrosslinked fluororubber and fluororesin may be obtained by mixing an aqueous dispersion of uncrosslinked fluororubber and an aqueous dispersion of fluororesin, coagulating the mixture, collecting the coagulated product, and optionally drying the coagulated product.

Some crosslinking systems for uncrosslinked fluororubber require a crosslinker. Thus, a crosslinker may be added to the coagulated product obtained by co-coagulating uncrosslinked fluororubber and fluororesin, thereby providing a crosslinkable composition. The crosslinkable composition may contain a crosslinker to be used in each crosslinking system. It may also contain any of the aforementioned additives.

In a usual manner, a crosslinker is first added to the coagulated product, and then the coagulated product and the crosslinker are mixed with each other. The mixing may be performed at a temperature lower than the melting point of the fluororesin by a usual mixing method using, for example, a kneader.

The crosslinking system for the uncrosslinked fluororubber is preferably at least one selected from the group consisting of a peroxide crosslinking system and a polyol crosslinking system. The peroxide crosslinking system is preferred from the viewpoint of chemical resistance, whereas the polyol crosslinking system is preferred from the viewpoint of heat resistance.

Thus, the crosslinker is preferably at least one selected from the group consisting of polyol crosslinkers and peroxide crosslinkers.

The amount of the crosslinker may be appropriately adjusted in accordance with the type of crosslinker. It is preferably 0.2 to 5.0 parts by mass, more preferably 0.3 to 3.0 parts by mass, for 100 parts by mass of the uncrosslinked fluororubber.

Peroxide crosslinking can be performed using a peroxide-crosslinkable uncrosslinked fluororubber and an organic peroxide as a crosslinker.

Any peroxide-crosslinkable uncrosslinked fluororubber may be used as long as it is an uncrosslinked fluororubber having a peroxide-crosslinkable moiety. Any peroxide-crosslinkable moiety may be used, and examples thereof include iodine-containing moieties and bromine-containing moieties.

The organic peroxide may be any organic peroxide capable of easily generating peroxy radicals in the presence of a heat or oxidation-reduction system. Examples thereof include 1,1-bis(t-butylperoxy)-3,5,5-trimethylcyclohexane, 2,5-dimethylhexane-2,5-dihydroperoxide, di-t-butyl peroxide, t-butylcumyl peroxide, dicumyl peroxide, α,α-bis(t-butylperoxy)-p-diisopropylbenzene, 2,5-dimethyl-2,5-di(t-butylperoxy)hexane, 2,5-dimethyl-2,5-di(t-butylperoxy)-hexyne-3, benzoyl peroxide, t-butylperoxy benzene, t-butylperoxy maleate, t-butylperoxyisopropyl carbonate, and t-butylperoxy benzoate. Among these, 2,5-dimethyl-2,5-di(t-butylperoxy)hexane and 2,5-dimethyl-2,5-di(t-butylperoxy)-hexyne-3 are preferred.

The amount of the organic peroxide is preferably 0.1 to 15 parts by mass, more preferably 0.3 to 5 parts by mass, for 100 parts by mass of the uncrosslinked fluororubber.

In the case of using an organic peroxide as a crosslinker, the crosslinkable composition preferably further contains a crosslinking aid. Examples of the crosslinking aid include cyanurate, triallyl isocyanurate (TAIC), triacrylformal, triallyl trimellitate, N,N′-m-phenylene bismaleimide, dipropargyl terephthalate, diallyl phthalate, tetraallyl terephthalate amide, triallyl phosphate, bismaleimide, fluorinated triallyl isocyanurate (1,3,5-tris(2,3,3-trifluoro-2-propenyl)-1,3,5-triazine-2,4,6-trione), tris(diallylamine)-S-triazine, N,N-diallyl acrylamide, 1,6-divinyldodecafluorohexane, hexaallyl phosphoramide, N,N,N′,N′-tetraallylphthalamide, N,N,N′,N′-tetraallylmalonamide, trivinyl isocyanurate, 2,4,6-trivinylmethyltrisiloxane, tri(5-norbornene-2-methylene)cyanurate, and triallyl phosphite. Triallyl isocyanurate (TAIC) is preferred among these because it is excellent in crosslinkability, mechanical properties, and sealability.

The amount of the crosslinking aid is preferably 0.01 to 10 parts by mass, more preferably 0.01 to 7.0 parts by mass, still more preferably 0.1 to 5.0 parts by mass, for 100 parts by mass of the uncrosslinked fluororubber. Less than 0.01 parts by mass of the crosslinking aid may deteriorate the mechanical properties and the sealability, whereas more than 10 parts by mass thereof tends to deteriorate the heat resistance and the durability of the automotive filler cap.

Polyol-crosslinking can be performed using a polyol-crosslinkable uncrosslinked fluororubber and a polyhydroxy compound as a crosslinker. The amount of the polyhydroxy compound in a polyol crosslinking system is preferably 0.01 to 8 parts by mass for 100 parts by mass of the polyol-crosslinkable uncrosslinked fluororubber. The polyhydroxy compound in an amount within such a range can achieve sufficient polyol-crosslinking. The amount is more preferably 0.02 to 5 parts by mass.

Any polyol-crosslinkable uncrosslinked fluororubber may be used as long as it is an uncrosslinked fluororubber having a polyol-crosslinkable moiety. Any polyol-crosslinkable moiety may be used, and examples thereof include moieties having a vinylidene fluoride (VdF) unit. The crosslinked moiety may be introduced by, for example, a method of copolymerizing a monomer that gives a crosslinked moiety in polymerization of the uncrosslinked fluororubber.

The polyhydroxy compound is preferably a polyhydroxy aromatic compound in terms of the excellent heat resistance.

Any polyhydroxy aromatic compound may be used, and examples thereof include 2,2-bis(4-hydroxyphenyl)propane (hereinafter, referred to as bisphenol A), 2,2-bis(4-hydroxyphenyl)perfluoropropane (hereinafter, referred to as bisphenol AF), resorcin, 1,3-dihydroxybenzene, 1,7-dihydroxynaphthalene, 2,7-dihydroxynaphthalene, 1,6-dihydroxynaphthalene, 4,4′-dihydroxydiphenyl, 4,4′-dihydroxystilbene, 2,6-dihydroxyanthracene, hydroquinone, catechol, 2,2-bis(4-hydroxyphenyl)butane (hereinafter, referred to as bisphenol B), 4,4-bis(4-hydroxyphenyl)valerate, 2,2-bis(4-hydroxyphenyl)tetrafluorodichloropropane, 4,4′-dihydroxydiphenyl sulfone, 4,4′-dihydroxydiphenyl ketone, tri(4-hydroxyphenyl)methane, 3,3′,5,5′-tetrachloro bisphenol A, and 3,3′,5,5′-tetrabromobisphenol A. Each of these polyhydroxy aromatic compounds may be in the form of an alkali metal salt or an alkaline earth metal salt. In the case of using an acid for coagulating the copolymer, it is preferable to use no metal salt. The amount of the polyhydroxy aromatic compound is 0.1 to 15 parts by mass, preferably 0.5 to 5 parts by mass, for 100 parts by mass of the uncrosslinked fluororubber.

If a polyhydroxy compound is used as a crosslinker, the crosslinkable composition preferably further contains a crosslinking accelerator. A crosslinking accelerator promotes formation of an intramolecular double bond by dehydrofluorination of the polymer main chain and addition of a polyhydroxy compound to the generated double bond.

The crosslinking accelerator may be combined with an acid acceptor (e.g. magnesium oxide) or a crosslinking aid (e.g. calcium hydroxide).

Examples of the crosslinking accelerator include onium compounds. The crosslinking accelerator is preferably at least one onium compound selected from the group consisting of ammonium compounds such as quaternary ammonium salts, phosphonium compounds such as quaternary phosphonium salts, oxonium compounds, sulfonium compounds, cyclic amines, and monofunctional amine compounds. It is more preferably at least one selected from the group consisting of quaternary ammonium salts and quaternary phosphonium salts.

Any quaternary ammonium salts may be used, and examples thereof include 8-methyl-1,8-diazabicyclo[5.4.0]-7-undecenium chloride, 8-methyl-1,8-diazabicyclo[5.4.0]-7-undecenium iodide, 8-methyl-1,8-diazabicyclo[5.4.0]-7-undecenium hydroxide, 8-methyl-1,8-diazabicyclo[5.4.0]-7-undecenium methyl sulfate, 8-ethyl-1,8-diazabicyclo[5.4.0]-7-undecenium bromide, 8-propyl-1,8-diazabicyclo[5.4.0]-7-undecenium bromide, 8-dodecyl-1,8-diazabicyclo[5.4.0]-7-undecenium chloride, 8-dodecyl-1,8-diazabicyclo[5.4.0]-7-undecenium hydroxide, 8-eicosyl-1,8-diazabicyclo[5.4.0]-7-undecenium chloride, 8-tetracosyl-1,8-diazabicyclo[5.4.0]-7-undecenium chloride, 8-benzyl-1,8-diazabicyclo[5.4.0]-7-undecenium chloride (hereinafter, referred to as DBU-B), 8-benzyl-1,8-diazabicyclo[5.4.0]-7-undecenium hydroxide, 8-phenethyl-1,8-diazabicyclo[5.4.0]-7-undecenium chloride, and 8-(3-phenylpropyl)-1,8-diazabicyclo[5.4.0]-7-undecenium chloride. DBU-B is preferred among these in terms of crosslinkability, mechanical properties, and sealability.

Any quaternary phosphonium salts may be used, and examples thereof include tetrabutylphosphonium chloride, benzyltriphenylphosphonium chloride (hereinafter, referred to as BTPPC), benzyltrimethylphosphonium chloride, benzyltributylphosphonium chloride, tributylallylphosphonium chloride, tributyl-2-methoxypropylphosphonium chloride, and benzylphenyl(dimethylamino)phosphonium chloride. Benzyltriphenylphosphonium chloride (BTPPC) is preferred among these in terms of crosslinkability, mechanical properties, and sealability.

The crosslinking accelerator may be a solid solution of a quaternary ammonium salt and bisphenol AF, a solid solution of a quaternary phosphonium salt and bisphenol AF, or a chlorine-free crosslinking accelerator disclosed in JP H11-147891 A.

The amount of the crosslinking accelerator is preferably 0.01 to 8 parts by mass, more preferably 0.02 to 5 parts by mass, for 100 parts by mass of the uncrosslinked fluororubber. Less than 0.01 parts by mass of the crosslinking accelerator may fail to achieve sufficient crosslinking of the uncrosslinked fluororubber, deteriorating the properties of the resulting automotive filler cap, such as heat resistance. More than 8 parts by mass thereof tends to deteriorate the mold-processability of the crosslinkable composition, to decrease the elongation of the gasket among the mechanical properties, and to deteriorate the sealability.

In order to improve the compatibility between the fluororesin and the uncrosslinked fluororubber, the crosslinkable composition may contain at least one polyfunctional compound. A polyfunctional compound is a compound having two or more of the same or different structural functional groups in a molecule.

The functional groups in the polyfunctional compound may be any functional groups which are commonly known to have reactivity. Examples of the functional groups include carbonyl, carboxyl, haloformyl, amide, olefin, amino, isocyanate, hydroxy, and epoxy groups.

A compound having these functional groups not only has high affinity with the uncrosslinked fluororubber but also reacts with a functional group which is known to have reactivity in the fluororesin. In addition, the compound having these functional groups is expected to improve the compatibility.

The crosslinkable composition containing the uncrosslinked fluororubber and the fluororesin preferably satisfies a volume ratio {(uncrosslinked fluororubber)/(fluororesin)} of 60/40 to 95/5. If the amount of the fluororesin is too small, the automotive filler cap of the present invention may fail to have sufficient low adhesion property. If the amount of the fluororesin is too large, the rubber elasticity may deteriorate. The ratio {(uncrosslinked fluororubber)/(fluororesin)} is more preferably 65/35 to 95/5, still more preferably 70/30 to 90/10, because such ratios can provide both good flexibility owing to the fluororubber and good low adhesion property owing to the fluororesin.

The crosslinkable composition may contain any of typical additives that are blended into the uncrosslinked fluororubber as appropriate. Examples of such additives include fillers, processing aids, plasticizers, colorants, stabilizers, adhesive aids, release agents, electro-conductivity-imparting agents, thermal-conductivity-imparting agents, surface non-adhesive agents, flexibility-imparting agents, heat-resistance improvers, and flame retarders. These additives may be used to the extent that they do not deteriorate the effects of the present invention.

### (II) Molding and Crosslinking

This step includes molding and crosslinking the mixture obtained in the mixing step (I) to produce a crosslinked molded product having substantially the same shape as that of the elastic component to be produced.

The order of molding and crosslinking is not limited. It may be possible to perform molding first and then perform crosslinking, or first crosslinking and then molding. It may also be possible to simultaneously perform molding and crosslinking.

The molding may be performed by, for example, press molding using a mold or injection molding, but the molding method is not limited thereto.

The crosslinking may be performed by, for example, steam crosslinking, a normal crosslinking in which crosslinking is initiated by heating, or radiation crosslinking. Crosslinking by heating is particularly preferred.

Crosslinking by heating is preferred in the present invention because the fluororesin smoothly transfers to the surface layer of the crosslinkable composition.

The crosslinking temperature is not lower than the crosslinking temperature of the uncrosslinked fluororubber, and is preferably lower than the melting point of the fluororesin. Crosslinking at a temperature of not lower than the melting point of the fluororesin may fail to provide a molded product having many protrusions.

The crosslinking temperature is more preferably not higher than the temperature 5° C. or more lower than the melting point of the fluororesin because such a temperature makes it possible to form protrusions including the fluororesin on the surface of the crosslinked molded product through the heating to be mentioned later. The lower limit of the crosslinking temperature is the crosslinking temperature of the uncrosslinked fluororubber. The time for crosslinking may be appropriately adjusted depending on the factors such as the type of crosslinker, and may be, for example, 1 minute to 24 hours.

The method and conditions for molding and crosslinking may be adopted within the range commonly employed in the art. Molding and crosslinking may be performed in any order, and may be simultaneously performed.

The specific crosslinking conditions which are not limited may be appropriately adjusted depending on the conditions such as the type of the crosslinker to be used in the range of, typically, a crosslinking temperature of 150° C. to 250° C. and a crosslinking time of 1 minute to 24 hours. The molding and crosslinking conditions preferably include a temperature less than the melting point of the fluororesin, more preferably not higher than the temperature 5° C. lower than the melting point of the fluororesin in terms of forming protrusions made of the fluororesin on the surface of a crosslinked molded product in the step of heating mentioned below. The lower limit of the temperature is the crosslinking temperature of the fluororubber.

In some cases, a post-treatment called secondary crosslinking is performed after the first crosslinking (primary crosslinking) in the crosslinking of uncrosslinked rubber. As will be mentioned in the following section of “(III) Heating”, a conventional secondary crosslinking is a different treatment from the molding and crosslinking (II) and the heating (III) of the present invention.

### (III) Heating

This heating step (III) includes heating the resulting molded, crosslinked product to a temperature not lower than the melting point of the fluororesin. The heating (III) enables formation of protrusions (mainly made of the fluororesin) on the surface of an elastic component to be produced.

The heating (III) in the present invention is a step for increasing the proportion of the fluororesin on the surface of the molded, crosslinked product. In order to achieve this purpose, the heating temperature is not lower than the melting point of the fluororesin but lower than the pyrolysis temperatures of the fluororubber and the fluororesin.

If the heating temperature is lower than the melting point of the fluororesin, the fluororesin may fail to sufficiently precipitate and therefore fail to form protrusions on the surface of the molded, crosslinked product. As a result, the proportion of the fluororesin on the surface of the gasket cannot be sufficiently high. In order to avoid pyrolysis of the fluororubber and the fluororesin, the heating temperature is required to be below the lower one of the pyrolysis temperatures of the fluororubber and the fluororesin. The heating temperature is preferably not lower than the temperature 5° C. higher than the melting point of the fluororesin in order to easily impart low adhesion property to the molded, crosslinked product in a short time.

In the heating (III), the heating temperature closely correlates with the heating time. At a heating temperature that is relatively close to the lower limit, the heating is preferably performed for a relatively long time; at a heating temperature that is relatively close to the upper limit, the heating is preferably performed for a relatively short time.

As mentioned above, the heating time may be appropriately adjusted depending on the heating temperature. Still, too long a heating treatment may cause heat degradation of the fluororubber. Thus, the heating time is practically up to 96 hours except the case of using a fluororubber that is excellent in heat resistance.

Normally, the heating time is preferably 1 minute to 72 hours, more preferably 1 minute to 48 hours, still more preferably 1 minute to 24 hours for good productivity. In terms of providing an automotive filler cap with more excellent low adhesion property, the heating time is preferably 12 hours or longer.

In the gasket produced through the steps (I) to (III), the fluororesin is precipitated on the entire surface of the gasket and then formed into protrusions. However, in the gasket used for the automotive filler cup of the present invention, if the fluororesin is precipitated only in the portion where the gasket and the filler opening are in contact with each other, no protrusions are required in the portion other than the contact portion of the gasket and the filler opening. A gasket with such a structure may be produced by, after the step (III), a treatment such as grinding to remove the precipitated fluororesin or protrusions in the portion where no protrusions are required, for example.

Conventional secondary crosslinking is a treatment for completely decomposing the crosslinker remaining after primary crosslinking to complete the crosslinking of a fluororubber, thereby improving the mechanical properties and the compression set of the molded, crosslinked product.

Thus, although the conventional secondary crosslinking conditions (heating conditions), which do not suppose the existence of fluororesin, accidentally correspond to the heating conditions of the heating step, the conditions are just employed so as to complete the crosslinking of uncrosslinked fluororubber (completely decompose the crosslinker) without considering the existence of the fluororesin in the secondary crosslinking as a factor of setting the crosslinking conditions. Therefore, in the case of blending fluororesin, it is impossible to lead to the conditions for heat-softening or melting the fluororesin in a crosslinked rubber product (which is not an uncrosslinked rubber product).

In the molding and crosslinking (II), secondary crosslinking may be performed so as to complete the crosslinking of the uncrosslinked fluororubber (to decompose the crosslinker completely).

In some cases, the remaining crosslinker is decomposed in the heating (III), whereby the crosslinking of the uncrosslinked fluororubber is completed. However, such crosslinking of the uncrosslinked fluororubber in the heating (III) is merely an additional effect.

The heating (III) may be followed by a step of disposing a ring spring as appropriate.

For the automotive filler cap produced by a method including the steps of mixing (I), molding and crosslinking (II), and heating (III), presumably, the gasket has protrusions formed on the surface thereof and the proportion of the fluororesin increases in the surface region (including the inside of the protrusions) as a result of transfer of the fluororesin to the surface.

In particular, the mixture produced in the mixing (I) presumably has a structure in which the uncrosslinked fluororubber forms a continuous phase and the fluororesin forms a dispersing phase, or a structure in which the uncrosslinked fluororubber and the fluororesin each form a continuous phase. Such a structure allows smooth crosslinking in the molding and crosslinking (II), uniform crosslinking in the resulting crosslinked product, and smooth transfer of the fluororesin to the surface in the heating (III), resulting in an increased proportion of the fluororesin on the surface region of the gasket.

In order to allow the fluororesin to transfer to the surface layer smoothly, it is particularly excellent that the heating is performed at a temperature of not lower than the melting point of the fluororesin.

The state that the proportion of the fluororesin is increased on the surface region of the gasket (the state that the proportion of the fluororesin on the surface of the gasket is higher than the inside region) can be verified by chemical analysis, such as ESCA or IR analysis, of the surface of the gasket.

For example, ESCA can identify the atomic groups present between the surface and a depth of about 10 nM of the gasket. After the heating, the ratio (P_{ESCA}1/P_{ESCA}2) between the peak (P_{ESCA}1) of the bond energy assigned to the fluororubber and the peak (_{PESCA}2) assigned to the fluororesin is smaller than that before the heating; in other words, the number of atomic groups of the fluororesin increases.

IR analysis can identify the atomic groups present between the surface and a depth of about 0.5 to 1.2 μm of the gasket. After the heating, the ratio (P_{IR0.5}1/P_{IR0.5}2) between the peak (P_{IR0.5}1) of characteristic absorption assigned to the fluororubber and the peak (P_{IR0.5}2) assigned to the fluororesin at a depth of 0.5 μm is smaller than that before the heating; in other words, the number of atomic groups of the fluororesin increases. Furthermore, the ratio (P_{IR0.5}1/P_{IR0.5}2) at a depth of 0.5 μm is smaller in comparison with the ratio (P_{IR1.2}1/P_{IR1.2}2) at a depth of 1.2 μm. This indicates that the proportion of the fluororesin is higher at regions closer to the surface.

### EXAMPLES

The present invention will be described hereinbelow referring to, but not limited to, examples.

The properties herein were measured by the following methods.

### (1) Monomer Composition of Fluororesin

The monomer composition of the fluororesin was determined by ¹⁹F-NMR using a nuclear magnetic resonance device AC300 (Bruker-Biospin) at a measurement temperature of (melting point of polymer+50° C.).

### (2) Melting Point of Fluororesin

Calorimetry of the fluororesin was performed using a differential scanning calorimeter RDC220 (Seiko Instruments Inc.) in conformity with ASTM D-4591 at a temperature-increasing rate of 10° C./min. As the temperature once reached the point of (heat absorption completion temperature (the peak of melting point)+30° C.), the temperature was lowered to 50° C. at a temperature-decreasing rate of −10° C./min, and then the temperature was re-increased to the point of (heat absorption completion temperature+30° C.) at a temperature-increasing rate of 10° C./min. The melting point was determined based on the peak of the heat-absorption curve obtained.

### (3) Melt Flow Rate (MFR) of Fluororesin

The MFR was determined as follows. A polymer was ejected from a nozzle having an inner diameter of 2 mm and a length of 8 mm for 10 minutes at a temperature of 280° C. or 327° C. and a load of 5 kg using a melt indexer (Toyo Seiki Seisaku-sho, Ltd.) in conformity with ASTM D3307-01. The amount (g/10 min) of the polymer ejected was defined as the MFR.

### (4) Storage Elastic Modulus (E′) of Fluororesin

The storage elastic modulus was defined as a value determined by dynamic viscoelasticity measurement at 70° C. A sample having a length of 30 mm, a width of 5 mm, and a thickness of 0.25 mm was determined using a dynamic viscoelasticity analyzer DVA220 (IT KEISOKU SEIGYO K.K.) in a tensile mode at a grip width of 20 mm, a measurement temperature of from 25° C. to 200° C., a temperature-increasing rate of 2° C./rain, and a frequency of 1 Hz.

### (5) Crosslinkability (Vulcanizability)

The minimum torque (ML), maximum torque (MH), induction time (T10), and optimal scorch time (T90) were measured using a curelastometer type II (JSR Corp.).

### (6) 100% Modulus (M100)

This value was measured in conformity with JIS K6251.

### (7) Tensile Strength at Break (Tb)

This value was measured in conformity with JIS K6251.

### (8) Tensile Elongation at Break (Eb)

This value was measured in conformity with JIS K6251.

### (9) Hardness (Shore A)

This value was measured using a durometer type A in conformity with JIS K6253 (peak value).

### (10) Compression Set

The compression set after 70-hour test at 200° C. was measured in conformity with JIS K6262.

### (11) Proportion of Area of Region Having Protrusions, Heights of Protrusions, Bottom Cross-Sectional Area of Protrusions, and Number of Protrusions

The proportion of the area of the region having protrusions, the heights of protrusions, the bottom cross-sectional areas of protrusions, the number of protrusions, and the like were calculated using a color 3D laser microscope (VK-9700, Keyence Corp.) and WinRooF Ver. 6.4.0 (MITANI CORP.) as an analysis software. The proportion of the area of the region having protrusions was determined as the proportion of the sum of the bottom cross-sectional areas of the protrusions to the whole area measured. The number of protrusions was the number of protrusions within the measurement area in terms of the number per mm².

### (12) Adhesion of Fuel Filler Cap

Adhesion of the filler cap was observed as follows.

The packing for a fuel filler of the present invention was fitted into a commercially available fuel filler cap (designed for HONDA vehicles, type: 17670-SJA-013) as illustrated in FIG. 2 and the filler cap was attached to a commercially available fuel filler pipe (designed for HONDA vehicles, type: 17670-TM8-013). The filler pipe with the cap was placed in a heating furnace at 150° C. for 72 hours and then allowed to stand at normal temperature for 24 hours. The fuel filler cap was then taken off the fuel filler pipe and observed whether or not the rubber adhered to the pipe.

The adhesion state was observed with an optical microscope (×10) and evaluated according to the following criteria: ∘: no adhesion; x: having adhesion.

### (13) Adhesion of Oil Filler Cap

Adhesion of the filler cap was observed as follows.

The packing for a fuel filler of the present invention was fitted into a commercially available oil filler cap (designed for HONDA vehicles, type: 15610-PFB-000) as illustrated in FIG. 3 and the oil filler cap was attached to a commercially available head cover (designed for HONDA vehicles, type: 12310-RBJ-003). The head cover with the cap was placed in a heating furnace at 150° C. for 72 hours and was then allowed to stand at normal temperature for 24 hours. The head cover was then taken off and observed whether or not the rubber adhered to the head cover.

The adhesion state was observed with an optical microscope (×10) and evaluated according to the following criteria: ∘: no adhesion; x: having adhesion.

The materials mentioned in the tables and the description are listed below.

### Filler

Carbon black (MT CARBON(N990), Cancarb)

### Crosslinker

Bisphenol AF, special grade (Wako Pure Chemical Industries, Ltd.)

### Crosslinking Promoter

BTPPC, special grade (Wako Pure Chemical Industries, Ltd.)

### Acid Acceptor

Magnesium oxide (MA 150, Kyowa Chemical Industry Co., Ltd.)

### Crosslinking Aid

Calcium hydroxide (CALDIC 2000, Ohmi Chemical Industry Co., Ltd.)

### Fluororubber (A)

Aqueous dispersion of binary fluororubber (DAIKIN INDUSTRIES, Ltd., solids content: 26% by mass, fluororubber: VdF/HFP copolymer, VdF/HFP=22/78 (molar ratio)) (fluororubber dispersion (A))

### Fluororesin (B1)

Aqueous dispersion of NEOFLON FEP (TFE/HFP copolymer, DAIKIN INDUSTRIES, Ltd., solids content: 21% by mass, MFR: 31.7 g/10 min (measured at 327° C., a 5-kg load), melting point: 215° C., TFE/HFP=87.9/12.1 (molar ratio)) (fluororesin dispersion (B1))

### Fluororesin (B2)

Aqueous dispersion of NEOFLON FEP (TFE/HFP copolymer, DAIKIN INDUSTRIES, Ltd., solids content: 20.1% by mass, MFR: 7.5 g/10 min (measured at 280° C., a 5-kg load), melting point: 186° C., TFE/HFP=84.7/15.3 (molar ratio)) (fluororesin dispersion (B2))

### Fluororesin (C)

NEOFLON ETFE (Ethylene/TFE copolymer, trade name: EP-610, DAIKIN INDUSTRIES, Ltd.)

### (Preparation of Crosslinkable Composition 1)

Water (500 mL) and magnesium chloride (4 g) were preliminarily mixed to provide a solution. To this solution, 400 mL of a solution in which the fluororesin dispersion (B1) and the fluororubber dispersion (A) were mixed at a volume ratio (fluororubber/fluororesin) of 75/25 (solids content) was added in a 1-L mixer. The mixture was mixed for 5 minutes to cause co-coagulation.

Co-coagulated solids were collected, dried at 120° C. for 24 hours in a drying furnace, and mixed with a predetermined composition shown in Table 1 using an open roll, thereby preparing a crosslinkable composition 1.

### (Preparation of Crosslinkable Composition 2)

A crosslinkable composition 2 was prepared in the same manner as in Preparation of crosslinkable composition 1 except that the fluororesin dispersion (B2) was used instead of the fluororesin dispersion (B1).

### (Preparation of Crosslinkable Composition 3)

A solution prepared by mixing water (500 mL) and magnesium chloride (4 g) and the fluororubber dispersion (A) (400 mL) were charged into a 1-L mixer and mixed for 5 minutes to cause coagulation. Coagulated solids were collected and dried at 120° C. for 24 hours in a drying furnace. The dried, coagulated fluororubber (A) and the fluororesin (C) were charged into a 3-L pressure kneader at a volume ratio between the coagulated fluororubber (A) and the fluororesin (C) of 75/25, so as to give a packing factor by volume of 85%. They were kneaded until the temperature of the materials (fluororubber and fluororesin) reached 230° C., thereby preparing a compound. The compound was then mixed with a predetermined composition shown in Table 1 using an open roll, thereby preparing a crosslinkable composition 3.

### Example 1-1

### Molding and Crosslinking

The crosslinkable composition 1 was charged in a mold of a packing for a fuel filler, pressured at 10 MPa, and vulcanized at 170° C. for 10 minutes, and thereby formed into a crosslinked molded product with a similar cross section to that of the gasket (packing) 24 shown in FIG. 2 (outer diameter: 52.6 mm, inner diameter: 40 mm, height of cross section: 6.7 mm).

### Heating

The resulting molded, crosslinked product was heated in a heating furnace at 230° C. for 24 hours, whereby a packing for a fuel filler was produced. The crosslinking (vulcanization) characteristics of the packing were determined with a curelastometer (type II, JSR Corporation) at 170° C.

The resulting packing for a fuel filler was subjected to determinations of the number, the bottom cross-sectional areas, and the heights of the protrusions, the proportion of the area of the regions having the protrusions, and the adhesion state of the packing for a fuel filler. Table 1 shows the results.

### Example 1-2

A packing for a fuel filler was produced in the same manner as in Example 1-1 except that the crosslinkable composition 2 was used instead of the crosslinkable composition 1, and the same determinations as in the above were performed.

### Example 2-1

### Molding and Crosslinking

The full compound was charged into a mold of a packing for an oil filler, pressured at 10 MPa, and vulcanized at 170° C. for 10 minutes, and thereby formed into a molded, crosslinked product having a similar cross section to that of the gasket (packing) 34 in FIG. 3 (outer diameter: 40 mm, inner diameter: 34 mm, height of cross section: 5 mm).

### Heating

The resulting molded, crosslinked product was heated in a heating furnace at 230° C. for 24 hours, whereby a packing for an oil filler was produced. The crosslinking (vulcanization) characteristics of the packing were determined with a curelastometer (type II, JSR Corporation) at 170° C.

The resulting packing for an oil filler was subjected to determinations of the number, bottom cross-sectional areas, and heights of the protrusions, the proportion of the area of the regions having the protrusions, and the adhesion state of the packing for an oil filler. Table 1 shows the results.

### Example 2-2

A packing for an oil filler was produced in the same manner as in Example 2-1 except that the crosslinkable composition 2 was used instead of the crosslinkable composition 1, and the same determinations as in the above were performed.

### Comparative Example 1

A packing for a fuel filler was produced in the same manner as in Example 1-1 except that the crosslinkable composition 3 was used instead of the crosslinkable composition 1, and the same determinations as in the above were performed.

### Comparative Example 2

A packing for an oil filler was produced in the same manner as in Example 2-1 except that the crosslinkable composition 3 was used instead of the crosslinkable composition 1, and the same determinations as in the above were performed.

A transmission oil seal for automobiles was produced and the measurements were performed in the same manner as in Example 2-1 except that the crosslinkable composition 3 was used instead of the crosslinkable composition 1.

TABLE 1

| | Example | Example | Comparative | Example | Example | Comparative |
|---|---|---|---|---|---|---|
| | 1-1 | 1-2 | Example 1 | 2-1 | 2-2 | Example 2 |
| Crosslinkable fluororubber composition | | | | | | |
| (volume ratio) | | | | | | |
| Fluororubber (A) | 75 | 75 | 75 | 75 | 75 | 75 |
| Fluororesin (B1) | 25 | | | 25 | | |
| Fluororesin (B2) | | 25 | | | 25 | |
| Fluororesin (C) | | | 25 | | | 25 |
| Proportion of volume of fluororesin in | 25 | 25 | 25 | 25 | 25 | 25 |
| crosslinkable fluororubber composition [%] | | | | | | |
| Bisphenol AF (parts by mass) | 1.6 | 1.6 | 1.6 | 1.6 | 1.6 | 1.6 |
| BTPPC (parts by mass) | 0.3 | 0.3 | 0.3 | 0.3 | 0.3 | 0.3 |
| MgO (parts by mass) | 2.25 | 2.25 | 2.25 | 2.25 | 2.25 | 2.25 |
| Calcium hydroxide (parts by mass) | 4.5 | 4.5 | 4.5 | 4.5 | 4.5 | 4.5 |
| Carbon black (parts by mass) | 0.75 | 0.75 | 0.75 | 0.75 | 0.75 | 0.75 |
| Crosslinkability (vulcanizability) | | | | | | |
| Minimum torque ML [N] | 2.9 | 2.4 | 2.5 | 2.9 | 2.4 | 2.5 |
| Maximum torque MH [N] | 31.4 | 24 | 34.5 | 31.4 | 24 | 34.5 |
| Induction time T10 [min] | 2.3 | 2.9 | 4.1 | 2.3 | 2.9 | 4.1 |
| Optimal scorch time T90 [min] | 3.5 | 4.4 | 6.3 | 3.5 | 4.4 | 6.3 |
| Surface | | | | | | |
| Proportion of area of region having protrusions | 38.7 | 36.5 | 17.1 | 38.7 | 36.5 | 17.1 |
| [%] | | | | | | |
| Proportion of area of region having | 1.548 | 1.46 | 0.684 | 1.548 | 1.46 | 0.684 |
| protrusions/Proportion of volume of fluororesin in | | | | | | |
| crosslinkable fluororubber composition | | | | | | |
| Heights of protrusions [μm] | 0.44 to 1.91 | 0.43 to 1.88 | 0.11 to 1.90 | 0.44 to 1.91 | 0.43 to 1.88 | 0.11 to 1.90 |
| Bottom cross-sectional areas of protrusions [μm²] | 3.7 to 197.7 | 3.8 to 199.2 | 7.6 to 203.1 | 3.7 to 197.7 | 3.8 to 199.2 | 7.6 to 203.1 |
| Number of protrusions [pcs/mm²] | 8901 | 8893 | 3941 | 8901 | 8893 | 3941 |
| Compression set (200° C. × 70 h) [%] | 43 | 29.9 | 44 | 43 | 29.9 | 44 |
| Adhesion state | ◯ | ◯ | X | ◯ | ◯ | X |

### INDUSTRIAL APPLICABILITY

The automotive filler cap of the present invention has excellent low adhesion property in addition to normal sealing performance, and thus it is suitable for automotive fuel filler caps and automotive oil filler caps.

### REFERENCE SIGNS LIST

10, 24, 34: gasket
11: protrusions
21, 31: cap portion
22: screw portion
22a: thread
22b: rib
23: filler neck
23a, 33: filler opening
23b: filler neck-side screw
23c, 33a: sealing surface
24a: slit
31: cap portion
31a: bottom surface of the cap portion
32: cylindrical portion
35: groove
200: automotive fuel cap
300: automotive oil filler cap

1. An automotive filler cap configured to be attached to a filler opening of an automobile,
the automotive filler cap comprising a gasket configured to seal the filler opening by being pressed against the filler opening,
the gasket being made of a composition that contains a fluororubber and a fluororesin, the fluororesin being precipitated on the surface of the gasket,
the fluororesin comprising a copolymer that contains a polymerized unit based on tetrafluoroethylene and a polymerized unit based on hexafluoropropylene.

2. The automotive filler cap according to claim 1,
wherein the surface of the gasket comprises protrusions which are substantially made of the fluororesin contained in the composition.

3. The automotive filler cap according to claim 2,
wherein the proportion of the volume of the fluororesin in the gasket is 0.05 to 0.45,
the proportion of the area of regions having the protrusions on the surface of the gasket is 0.06 or higher, and
the proportion of the area of the regions having the protrusions on the surface of the gasket is 1.2 or more times as high as the proportion of the volume of the fluororesin in the gasket.

4. The automotive filler cap according to claim 2,
wherein each of the protrusions is 0.1 to 30.0 μm in height.

5. The automotive filler cap according to claim 2,
wherein each of the protrusions is 0.1 to 2000 μm² in bottom cross-sectional area.

6. The automotive filler cap according to claim 1,
wherein the fluororubber comprises a copolymer that contains a polymerized unit based on vinylidene fluoride and a polymerized unit based on at least one monomer selected from the group consisting of tetrafluoroethylene, hexafluoropropylene, and perfluoro(alkyl vinyl ether).

7. The automotive filler cap according to claim 1,
wherein the filler cap is an automotive fuel cap configured to be attached to a filler opening of a fuel tank of an automobile.

8. The automotive filler cap according to claim 1,
wherein the filler cap is an automotive oil filler cap configured to be attached to a filler opening for supplying a lubricant to an internal combustion engine of an automobile.
